(19) United States
(12) Patent Application Publication
(10) Pub. No.: US 2013/0067325 A1
(43) Pub. Date: Mar. 14, 2013

(54) DIGITAL BOOK DISPLAY DEVICE, DIGITAL BOOK DISPLAY METHOD, AND DIGITAL BOOK DISPLAY PROGRAM

(71) Applicants: Ryuji Ikeda, Osaka-shi (JP); Kazuhiro Miki, Osaka-shi (JP)

(72) Inventors: Ryuji Ikeda, Osaka-shi (JP); Kazuhiro Miki, Osaka-shi (JP)

(73) Assignee: SHARP KABUSHIKI KAISHA, Osaka-shi, Osaka (JP)

(21) Appl. No.: 13/699,486

(22) PCT Filed: Sep. 13, 2011
(86) PCT No.: PCT/JP2011/070874

§ 371 Date: Nov. 21, 2012

(30) Foreign Application Priority Data
Sep. 24, 2010 (JP) 2010-214511

(51) Int. Cl. G06F 17/21

(52) U.S. Cl. 715/256

(57) ABSTRACT

An electronic book display device of the present invention includes a reproduction information storage section (17) for storing reproduction information in which (A) mark information which is necessary for redisplaying a mark added to a text of electronic book information displayed on a display section (11) and (B) display state information which is necessary for reproducing a display state of the electronic book information displayed on a display section (11) at a point in time that the mark was added are associated with each other. The electronic book display device displays the electronic book information on the display section (11) on the basis of the reproduction information stored in the reproduction information storage section (17).

### TECHNICAL FIELD

The present invention relates to an electronic book display device for displaying electronic book information.

### BACKGROUND ART

Electronic book display devices for displaying electronic book information generally have a marking function so that a user can mark a desired text string in the displayed electronic book information in the same way as the user marks a text string in a printed book.

A mark made in a text string of an electronic book with the use of the marking function serves as a useful sign when the electronic book is read again later. The marking function is disclosed in, for example, an “electronic book display device” of Patent Literature 1.

In a general electronic book display device, in a case where a user adds a mark in an electronic book with the use of the marking function, the user adds a mark 104, with the use of a pen 103, to a desired part of electronic book information 102 displayed on a display screen 101 (see (a) of FIG. 2).

The mark 104 thus added is stored in the electronic book display device as mark information. Examples of the mark information encompass mark location information (mark start coordinate and mark end coordinate), line colors, and marked text strings. A plurality of stored marks are stored so as to be displayed as a list. For example, as illustrated in (b) of FIG. 2, a plurality of marks are displayed on the display screen 101 as a mark list 105.

A user can select a desired mark from the mark list 105 with the use of the pen 103. In this way, the marked part can be displayed again. Specifically, when the user selects a desired mark from the mark list 105, mark information associated with the desired mark is read out, and an electronic book is opened on the basis of the mark information thus read out, and as a result, the mark 104 is displayed at a predetermined location of the electronic book information 102 on the display screen 101 (see, for example, (c) of FIG. 2).

There is the following two methods for displaying a mark by opening an electronic book.

(1) A method for displaying a mark with use of the mark information.

(2) A method for displaying a mark with use of not only the mark information but also page information.

In the method (1), the electronic book information 102 and the mark 104 are selected from the mark list 105 displayed on the display screen 101 and subjected to steps (a) through (c) as illustrated in FIG. 10, and then are displayed on the display screen 101.

Specifically, in a case where the user selects a mark from the mark list 105 displayed on the display screen 101, the electronic book display device carries out the following steps: acquiring mark information of the mark thus selected ((a)); displaying the electronic book information 102 on the display screen 101 at a mark location indicated by the mark information thus acquired ((b)); and displaying the electronic book information 102 on the display screen 101 with the use of the mark information ((c)).

Meanwhile, in the method (2), the electronic book information 102 and the mark 104 are selected from the mark list 105 displayed on the display screen 101 and subjected to steps (d) through (g) as illustrated in FIG. 10, and then are displayed on the display screen 101.

Specifically, in a case where the user selects a mark from the mark list 105 displayed on the display screen 101, the electronic book display device carries out the following steps: acquiring the mark information and the page information selected by the user ((d)); acquiring a mark location from the mark information thus acquired and a page location where the mark is added from the page information thus acquired ((e)); displaying the electronic book information 102 on the display screen 101 at the page location thus acquired ((f)); and displaying the mark 104 on the display screen 101 with the use of the mark information ((g)).

The page information for use in the method (2) includes display location information, and the display location information encompasses two kinds of information as follows.

(2-1) Information dynamically calculated on a screen display basis in accordance with a display parameter such as font size. ((a) and (b) of FIG. 11)
(2-2) Information such that electronic book information is divided so as to have a predetermined data size. ((c) of FIG. 11)

### CITATION LIST

### Patent Literature

Patent Literature 1: Japanese Patent Application Publication, Tokukai, No. 2001-236360 (Publication Date: Aug. 31, 2001)

### SUMMARY OF INVENTION

### Technical Problem

As illustrated in FIG. 12, however, the method (1) can reproduce only display in which the mark 104 is added at the top of the display screen because the method (1) reproduces the mark with the use of only the mark information.

Further, as illustrated in FIG. 13, in a case where information shown in the aforementioned (2-1) is used as the display location information in the method (2), it is necessary to recalculate page information every time when a font size is changed.

Furthermore, as illustrated in FIG. 14, in a case where information shown in the aforementioned (2-2) is used as the display location information in the method (2), the mark 104 cannot be displayed if a divided range is larger than a screen size of the display screen 101.

As described above, when a user executes a reproduction operation of the mark with the use of the marking function in a conventional electronic book display device, a display location of the mark is different from a display location where the mark is added. This makes it difficult for a user to imagine about a relationship between a display state of electronic book information before the mark is added and a display state thereof after the mark is added.

Further, there arises another problem in that it takes time to reproduce the display of the mark or the mark is not displayed, because a font is changed after the mark is added.

The present invention has been made in view of the aforementioned problem, and an object of the present invention is to provide such an electronic book display device that, by setting a display location of a mark is to be the same as a location where the mark is added when a user executes a reproduction operation of the mark, (A) the user can easily imagine a relationship between a display state of electronic book information before the mark is added and a display state thereof after the mark is added and (B) the mark can be appropriately displayed in a short time even when a font is changed after the mark is added.

### Solution to Problem

In order to achieve the aforementioned object, an electronic book display device of the present invention includes: display means for displaying electronic book information; mark addition means for adding a mark to a text of the electronic book information displayed on the display means; and storage means for (A) causing (a) mark information of the mark which has been added by the mark addition means to the text of the electronic book information and (b) display state information, which indicates a display state of the electronic book information at a time that the mark was added, to be associated with each other so as to obtain reproduction information in which the mark information and the display state information are associated with each other and (B) storing the reproduction information, the display means displaying the electronic book information and the mark on the basis of the reproduction information of the storage means when the display means displays the electronic book information in which the mark has been added.

In order to achieve the aforementioned object, a method for displaying an electronic book of the present invention is a method for displaying electronic book for use in an electronic book terminal including: display means for displaying electronic book information; and storage means for (A) causing (a) mark information of a mark which has been added to a text of the electronic book information and (b) display state information, which indicates a display state of the electronic book information at a time that the mark was added, to be associated with each other so as to obtain reproduction information in which the mark information and the display state information are associated with each other and (B) storing the reproduction information, the method comprising the steps of: (i) reading out the reproduction information stored in the storage means; (ii) reproducing, on the basis of the display state information included in the reproduction information which has been read out in the step (i), the display state of the electronic book information at the time that the mark was added; and (iii) displaying, with the use of the mark information included in the reproduction information read out in the step (i), the mark at a predetermined location of the electronic book information which has been reproduced in the step (ii).

According to the aforementioned arrangement, storage means stores the mark addition means for adding mark to a text of the electronic book information displayed to the display means, the mark information of the mark added to the text of the electronic book information by the mark addition means, and the display state information when the mark is added are associated with one another and are stored as the reproduction information. In order to reproduce the mark, when the reproduction information is read out from the storage means, the mark information and the display state information associated with the mark information are read out. The display state information thus read out is necessary for reproducing a display state of the electronic book information displayed, to the display means, when the mark is added. Accordingly, the display state of the electronic book information displayed, to the display means, when the mark is added can be reproduced when the mark is reproduced.

Therefore, a user can easily recall the relationship between the display state of the electronic book information before the mark is added and the display state thereof after the mark is added, because a display state displayed when the mark is redisplayed is set to be the same as a display state of the mark displayed when the mark is added.

In a case where the display state information included in the reproduction information stored in the storage means is set to include font information, a font size becomes the font size used when the mark is added even if the font is changed after a mark is added. This makes it possible to surely redisplay the mark in a short time.

### Advantageous Effects of Invention

An electronic book display device of the present invention includes: display means for displaying electronic book information; mark addition means for adding a mark to a text of the electronic book information displayed on the display means; and storage means for (A) causing (a) mark information of the mark which has been added by the mark addition means to the text of the electronic book information and (b) display state information, which indicates a display state of the electronic book information at a time that the mark was added, to be associated with each other so as to obtain reproduction information in which the mark information and the display state information are associated with each other and (B) storing the reproduction information, the display means displaying the electronic book information and the mark on the basis of the reproduction information of the storage means when the display means displays the electronic book information in which the mark has been added. Therefore, a user can easily recall a relationship between a display state of electronic book information before the mark is added and a display state thereof after the mark is added, because a state of the mark displayed when the mark is redisplayed is the same as a state of the mark displayed when the mark is added. This makes it possible to improve usability for a user.

### BRIEF DESCRIPTION OF DRAWINGS

FIG. 1

FIG. 1 is a block diagram illustrating a schematic arrangement of an electronic book display device of the present invention.

FIG. 2

(a) through (c) of FIG. 2 are views illustrating simplified steps in which a mark is added, registered, and reproduced by a user in an electronic book display device.

FIG. 3

FIG. 3 is a view illustrating a screen image which is illustrated in a case where a mark is displayed in an electronic book display device.

FIG. 4

FIG. 4 is a view schematically illustrating a whole content of electronic book information.

FIG. 5

FIG. 5 is a view specifically illustrating reproduction information.

FIG. 6

FIG. 6 is a flowchart showing a flow of a mark reproduction process.

FIG. 7

(a) of FIG. 7 is a view illustrating a whole content, and (b) of FIG. 7 is a view illustrating a screen image which is displayed when a mark is reproduced.

FIG. 8

FIG. 8 is a flowchart showing a flow of a mark reproduction process.

FIG. 9

(a) of FIG. 9 is a screen image illustrating a state in which a mark is not displayed because of a change in font, and (b) of FIG. 9 is a screen image illustrating a state in which, when the mark is not displayed because of a change in font, a part which has been marked is moved to a head of a display screen.

FIG. 10

FIG. 10 is a view illustrating a flow of a mark redisplay process in a conventional electronic book display device.

FIG. 11

(a) through (c) of FIG. 11 are views for explaining display location information included in page information illustrated in FIG. 10.

FIG. 12

FIG. 12 is a view for explaining a conventional problem.

FIG. 13

FIG. 13 is a view for explaining a conventional problem.

FIG. 14

FIG. 14 is a view for explaining a conventional problem.

### DESCRIPTION OF EMBODIMENTS

The following description will discuss an embodiment of the present invention.

<Brief Description of Whole Electronic Book Display Device>

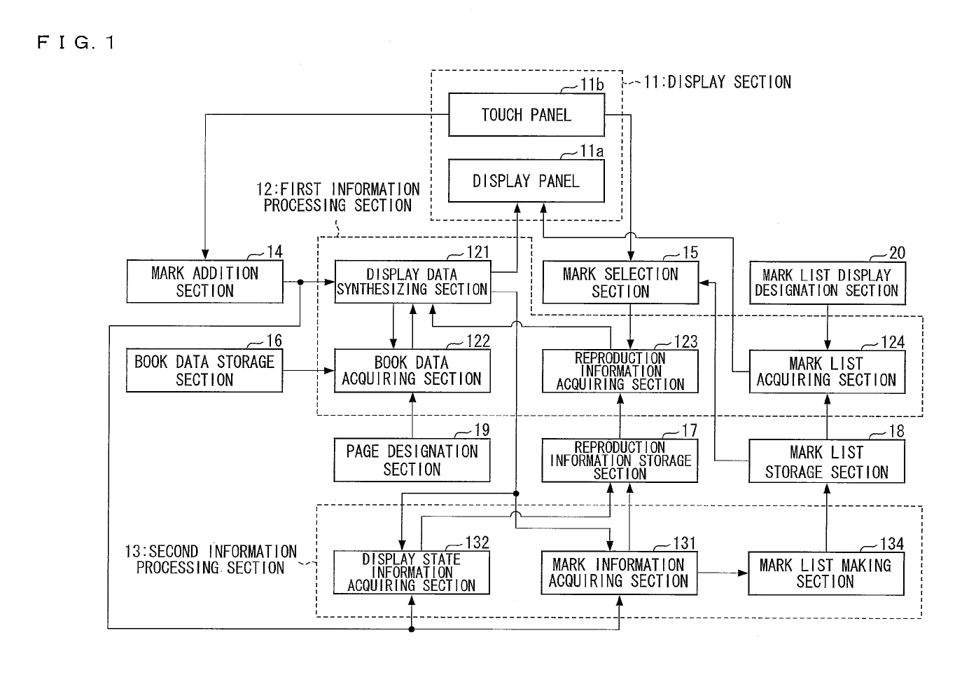

FIG. 1 is a block diagram illustrating a schematic arrangement of an electronic book display device according to the present embodiment.

As illustrated in FIG. 1, the electronic book display device includes a display section 11 (display means), a first information processing section 12, a second information processing section 13, a mark addition section 14 (mark addition means), a mark selection section 15, a book data storage section 16, a reproduction information storage section 17 (storage means), a mark list storage section 18, a page designation section 19, and a mark list display designation section 20.

The display section 11 includes: a display panel 11a which includes a liquid crystal display panel etc.; and a touch panel 11b which includes a touch sensor and is provided so as to cover an entire surface of a display screen of the display panel 11a. Since the touch panel 11b is provided so as to cover the entire surface of the display screen of the display panel 11a as described above, it is possible to know which part of the display panel 11a is touched, on the basis of a sensor output which is generated when the user touches the touch panel 11b with the use of a pen or his/her finger. Making use of this function realizes a marking function that allows a user to mark a desired part of electronic book information displayed on the display panel 11a.

In order to realize the marking function, it is also possible to mark a desired part with use of an external input device, such as a mouse, a keyboard, or a tablet, which is connected to the electronic book display device, instead of adding a mark by touching the touch panel 11b as described above.

The first information processing section 12 carries out a process for generating display data to be displayed in the display section 11. The first information processing section 12 includes a display data synthesizing section 121 (display reproduction means, display determination means, mark information display update means), a book data acquiring section 122, a reproduction information acquiring section 123 (information reading out means), and a mark list acquiring section 124. These sections will be described in detail later.

The second information processing section 13 carries out a process for acquiring and making various kinds of information for use in the first information processing section 12. The second information processing section 13 includes a mark information acquiring section 131, a display state information acquiring section 132, and a mark list making section 133. These sections will be described in detail later.

The mark addition section 14 obtains, on the basis of a detection signal supplied from the touch sensor in the touch panel 11b constituting the display section 11, location information of a mark which has been added by a user, with the use of a pen (not illustrated), to electronic book information displayed on the display screen of the display section 11. The mark addition section 14 supplies the location information to the display data synthesizing section 121 in the first information processing section 12, and to the mark information acquiring section 131 and the display state information acquiring section 132 in the second information processing section 13.

The mark selection section 15 obtains, on the basis of a detection signal supplied from the touch sensor in the touch panel 11b, a location touched by a user, with the use of a pen, in a mark list displayed on the display screen of the display section 11. Then the mark selection section 15 specifies, in a mark list stored in the mark list storage section 18, a mark which is displayed at the location thus touched. The mark thus specified is supplied, as mark selection information, from the mark selection section 15 to the reproduction information acquiring section 123 in the first information processing section 12.

The book data storage section 16 stores electronic book information.

In the reproduction information storage section 17, mark information obtained when a mark was added and display state information obtained when the mark was added are stored, as mark reproduction information (reproduction information), such that the mark information and the display state information are associated with each other.

The mark list storage section 18 stores a plurality of added marks in the form of a list.

The page designation section 19 supplies, to the book data acquiring section 122, page designation information for designating a page of the electronic book information. Note that “page” means a predetermined amount of electronic book data, which amount is set in each electronic book.

The mark list display designation section 20 supplies, to the mark list acquiring section 124, display designation information for designating the display of a mark list stored in the mark list storage section 18.

<Details of First Information Processing Section 12>

The following description will discuss sections of the first information processing section 12 in detail.

The display data synthesizing section 121 has an internal image buffer in which, when a mark is added, the book data acquired by the book data acquiring section 122 is synthesized with the mark on the basis of location information of the mark transmitted from the aforementioned mark addition section 14. Then the book data synthesized with the mark is supplied to the display panel 11a of the display section 11. In this way, the display panel 11a displays electronic book information to which the mark has been added. Note that the electronic book information to which the mark has been added is also supplied to the mark information acquiring section 131 and the display state information acquiring section 132 of the second information processing section 13.

Further, when the mark is reproduced, i.e., when a part where the mark has been added before is displayed again, the display data synthesizing section 121 (i) synthesizes the mark with the book data, acquired by the book data acquiring section 122, in the internal image buffer on the basis of mark reproduction information acquired by the reproduction information acquiring section 123 and (ii) supplies, to the display panel 11a, the book data with which the mark has been synthesized. In this way, the electronic book information to which the mark has been added is reproduced on the display panel 11a.

The internal image buffer inside the display data synthesizing section 121 is configured to temporarily store display data which is equivalent to one screen of the display screen of the display panel 11a in the display section 11.

The book data acquiring section 122 is configured to (i) acquire, in a unit of page, the electronic book information (book data) which is stored in the book data storage section 16 and (ii) supply the electronic book information to the display data synthesizing section 121 which follows the book data acquiring section 122.

Further, the book data acquiring section 122 acquires a necessary page of the electronic book data from the book data storage section 16 on the basis of the mark reproduction information supplied from the reproduction information acquiring section 123, and supplies the necessary page of the electronic book data to the display data synthesizing section 121 which follows the book data acquiring section 122.

The reproduction information acquiring section 123 acquires, on the basis of the mark selection information of the mark selection section 15, the mark reproduction information stored in the reproduction information storage section 17, and supplies the mark reproduction information thus acquired to the display data synthesizing section 121 and the book data acquiring section 122. The mark reproduction information includes mark information and display state information associated with the mark information.

The mark list acquiring section 124 (i) acquires, on the basis of the display designation information supplied from the mark list display designation section 20, the mark list stored in the mark list storage section 18, and (ii) supplies the mark list thus acquired to the display panel 11a of the display section 11.

<Details of Second Information Processing Section 13>

The following description will discuss sections of the second information processing section in detail.

The mark information acquiring section 131 receives, from the display data synthesizing section 121, the electronic book information which is to be displayed in the display section 11 and to which the mark has been added. Then, the mark information acquiring section 131 acquires, on the basis of the location information of the mark supplied from the mark addition section 14, the mark information included in the electronic book information. Specifically, the mark information acquiring section 131 acquires mark information such as location information (location information of a start and an end of a line) of the mark, mark color (line color) information, and a marked text string. Then the mark information acquiring section 131 supplies the mark information thus acquired to the reproduction information storage section 17 and the mark list making section 133.

The display state information acquiring section 132 receives, from the display data synthesizing section 121, the electronic book information which is to be displayed in the display section 11 and to which the mark has been added. Then, the display state information acquiring section 132 acquires, on the basis of the location information of the mark supplied from the mark addition section 14, the display state information (i.e., information which indicates a display state of the display screen of the display section 11) included in the electronic book information to which the mark is added. Then the display state information acquiring section 132 supplies the display state information thus acquired to the reproduction information storage section 17.

The mark information and the display state information will be described in detail later.

The mark list making section 133 accumulates the mark information supplied from the mark information acquiring section 131 so as to make a list. The list thus made is supplied to the mark list storage section 18. The mark list made here is arranged according to a sequence in which a user adds marks, i.e., in chronological order. However, the present invention is not limited to such an arrangement, and, for example, the list may be alphabetically arranged so that a user can easily find a desired mark.

<Brief Description of Processes from Mark Addition to Mark Reproduction>

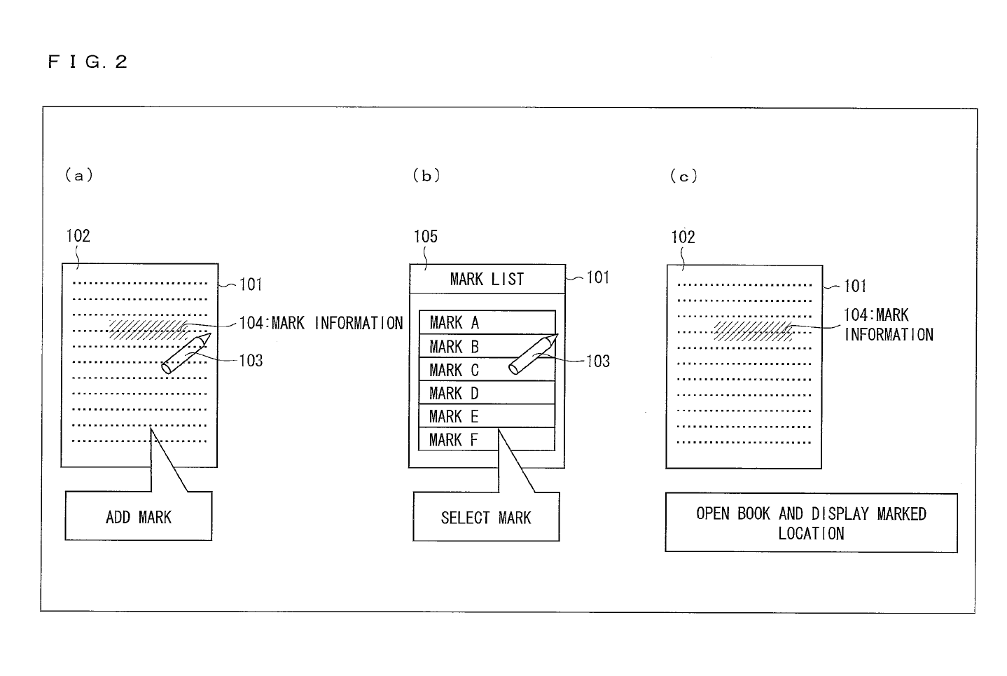

(a) through (c) of FIG. 2 are views illustrating simplified steps in which a mark is added, registered, and reproduced by a user.

In the electronic book display device having the aforementioned arrangement, in a case where a user adds a mark in a book with the use of the marking function, the user adds the mark 104, with the use of the pen 103, to a desired part of the electronic book information 102 displayed on the display screen 101 (see (a) of FIG. 2).

The mark 104 thus added is recorded inside the electronic book display device as mark information. Examples of the mark information recorded here encompass mark location information (a coordinate at which the mark starts and a coordinate at which the mark ends), line colors, and marked text strings. A plurality of marks are recorded so as to be displayed as a list.

As illustrated in (b) of FIG. 2, the marks which can be displayed as a list are displayed on the display screen 101 as a mark list 105. The user can select a desired mark from the mark list 105 with the use of the pen 103.

When the user selects a mark from the mark list 105, the electronic book display device opens an electronic book on the basis of the mark information associated with the mark, and displays the mark 104 at a predetermined location of the electronic book information 102 on the display screen 101 (see (c) of FIG. 2).

<Save of Mark Reproduction Information>

The following description will discuss a method for saving information for reproducing a display state of the electronic book information at a point in time when the mark 104 was added.

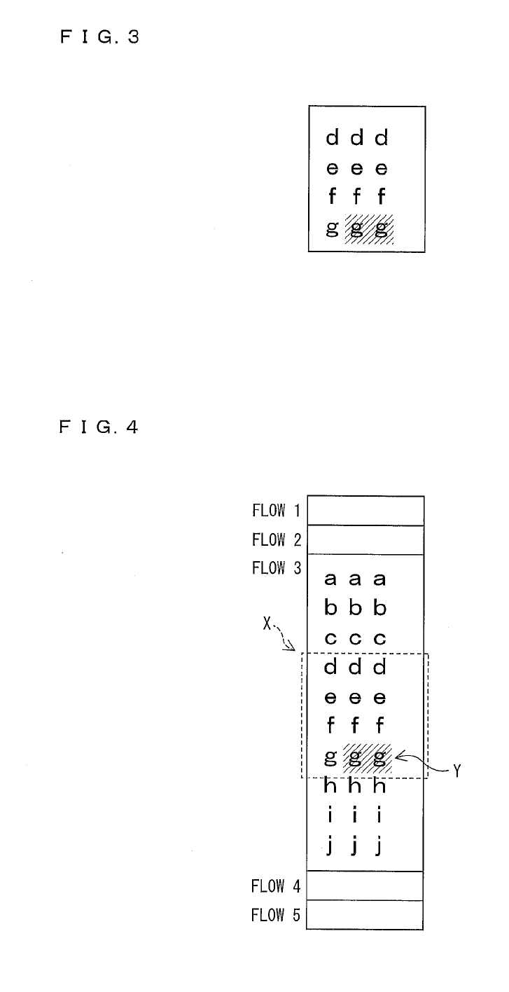

FIG. 3 is a view illustrating a screen image which is displayed in a case where a mark is displayed in an electronic book terminal.

FIG. 4 is a view schematically illustrating a whole content of electronic book information.

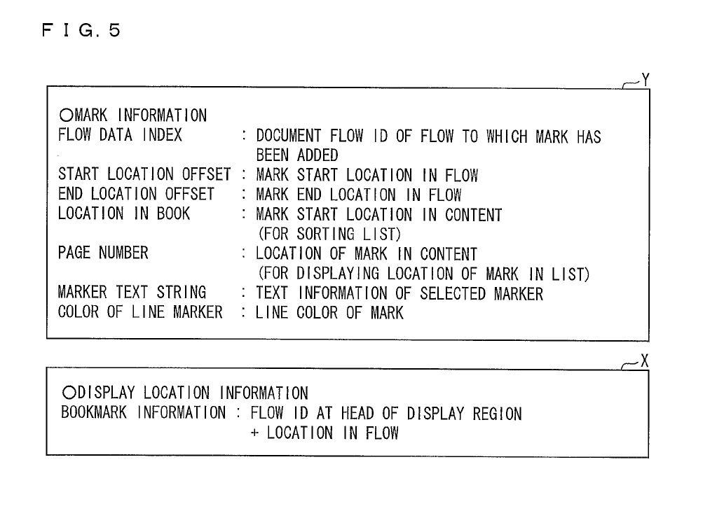

FIG. 5 is a view specifically illustrating mark reproduction information.

The screen image of FIG. 3 shows an example where the mark is added to a part “ff”. Note that the screen image illustrated in FIG. 3 shows how the electronic book information looks when displayed on the display screen of the display section 11. The electronic book as a whole is constituted by a plurality of flows (chapters), as illustrated in FIG. 4. FIG. 3 illustrates a screen image which shows a partial region of a flow 3.

The screen image of FIG. 3 is saved as mark reproduction information constituted by display location information X and mark information Y.

The display location information X (bookmark information) is display state information which is necessary for reproducing a display state of electronic book information which was being displayed on the display section 11 at a point in time when a mark was added. As illustrated in FIG. 5, the display location information X includes (A) a flow ID (here, in the case of the flow 3, ID=3) of a part of the electronic book information which part is located at a head of a display region and (B) location information (data location information) of a location in the flow (flow 3).

The mark information Y is information which is necessary for re-adding a mark which has been added to a text of the electronic book information displayed in the display section 11. As illustrated in FIG. 5, the mark information Y includes a flow data index (document flow ID of a flow to which a mark has been added), a start location offset (a mark start location in the flow), an end location offset (a mark end location in the flow), a location in a book (a mark start location in the content (for sorting a list)), a page number (a location of the mark in the content (for displaying the location of the mark in the list)), a marker text string (text information of a selected marker), and a color of a line marker (a line color of the mark).

The display location information (display state information) X and the mark information Y are associated with each other so as to be stored as the mark reproduction information in the reproduction information storage section 17 of FIG. 1.

<Reproduction Method 1>

The following description will discuss, with reference to FIGS. 1, 6, and 7, a mark reproduction process (a method for displaying an electronic book) with the use of the mark reproduction information stored in the reproduction information storage section 17.

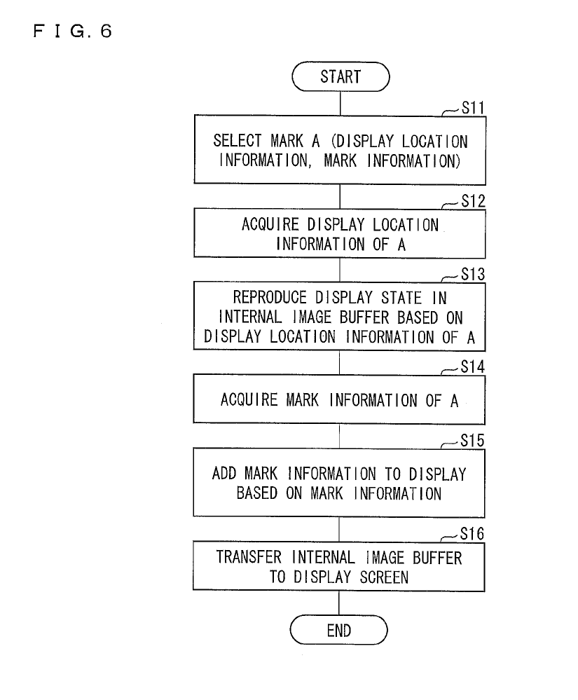

FIG. 6 is a flowchart showing a flow of a mark reproduction process.

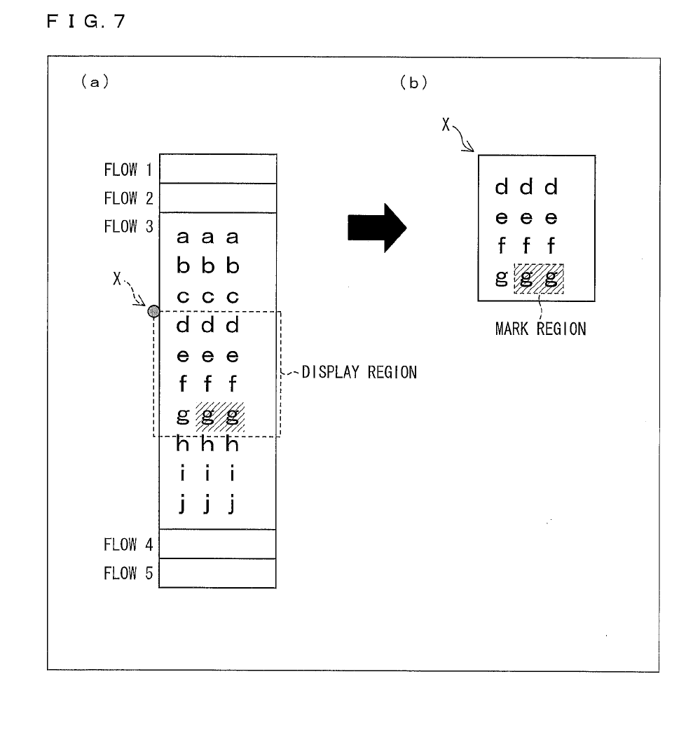

(a) of FIG. 7 is a view illustrating a whole content, and (b) of FIG. 7 is a view illustrating a screen image which is displayed when a mark is reproduced.

First, as shown in FIG. 6, a mark A is selected (Step S11). Specifically, a user selects the mark A, which is a desired mark, from the mark list 105 of (b) of FIG. 2. In response to this, the reproduction information acquiring section 123 acquires, from the reproduction information storage section 17, mark reproduction information (display location information, mark information) corresponding to the mark A, and transfers the mark reproduction information to the display data synthesizing section 121 (information reading out step, information reading out process).

Next, the display data synthesizing section 121 acquires display location information of the mark A from the mark reproduction information (Step S12), and reproduces a display state in the internal image buffer on the basis of the display location information of the mark A (Step S13). Note that the display location information includes (A) a flow ID (here, in the case of the flow 3, ID=3) of a part of the electronic book information which part is located at a head of a display region and (B) location information in the flow (flow 3). Accordingly, as illustrated in (a) of FIG. 7, the display data synthesizing section 121 reproduces a display region where a part starting from ddd and ending with ggg of the flow 3 of the whole content is displayed (display reproducing step, display reproduction process).

Then, the display data synthesizing section 121 acquires the mark information of the mark A from the mark reproduction information (Step S14), and adds, on the basis of the mark information of the mark A, the mark A to display which is reproduced in the internal image buffer (Step S15). The mark information includes a flow data index (document flow ID of a document to which a mark has been added), a start location offset (a mark start location in the flow), an end location offset (a mark end location in the flow), a location in a book (a mark start location in the content (for sorting a list)), a page number (a location of the mark in the content (for displaying the location of the mark in the list)), a marker text string (text information of a selected marker), and a color of a line marker (a line color of the mark). Specifically, as illustrated in (b) of FIG. 7, the display data synthesizing section 121 adds the mark to gg in the display region in the internal image buffer and adds gg as a mark region (mark addition step, mark addition process).

In this way, the display data synthesizing section 121 reproduces, in the internal image buffer, display data which is equivalent to one screen and constituted by (i) the mark and (ii) display including the mark.

Finally, the display data synthesizing section 121 transfers, to the display panel 11a of the display section 11, the display data which is equivalent to one screen and has been reproduced in the internal image buffer (Step S16).

Reproducing, as described above, a display state at the time that the mark was added allows reproducing a screen which starts from a location from which display started at the time that the mark was added. Accordingly, the user can easily recall a relationship between a display state before the mark was added and a display state after the mark was added.

<Reproduction Method 2>

Note that, when the display state is reproduced by the Reproduction method 1, a desired mark may not be displayed in the display region because of a change in font size. In such a case, the following reproduction method, in which display is carried out on the basis of the location information of the mark included in the mark information, is employed.

Specifically, the display data synthesizing section 121 determines whether or not the mark is displayed on the display panel 11a in a case where the mark is applied, by means of the mark addition section 14, at a predetermined location of the electronic book information which has been reproduced. Meanwhile, the display data synthesizing section 121 updates the display state with the use of the mark information in a case where the display data synthesizing section 121 determines that the mark is not displayed on the display means.

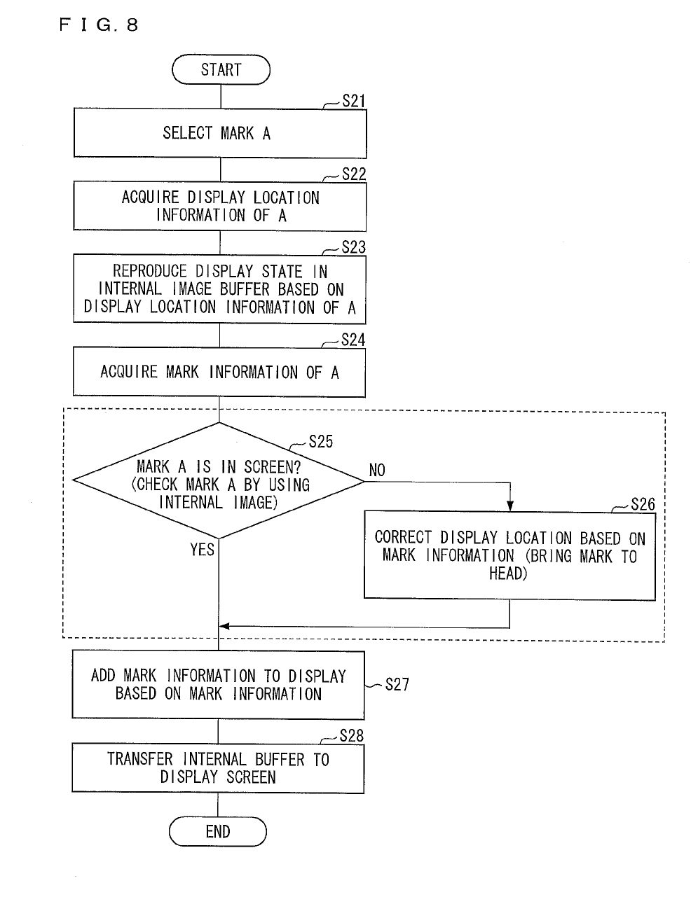

FIG. 8 is a flowchart showing a flow of a mark reproduction process.

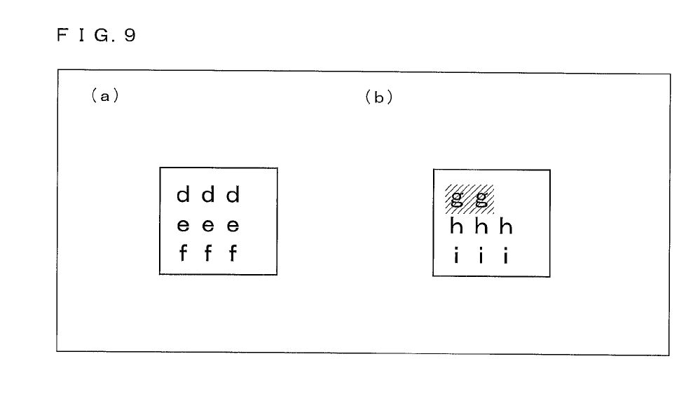

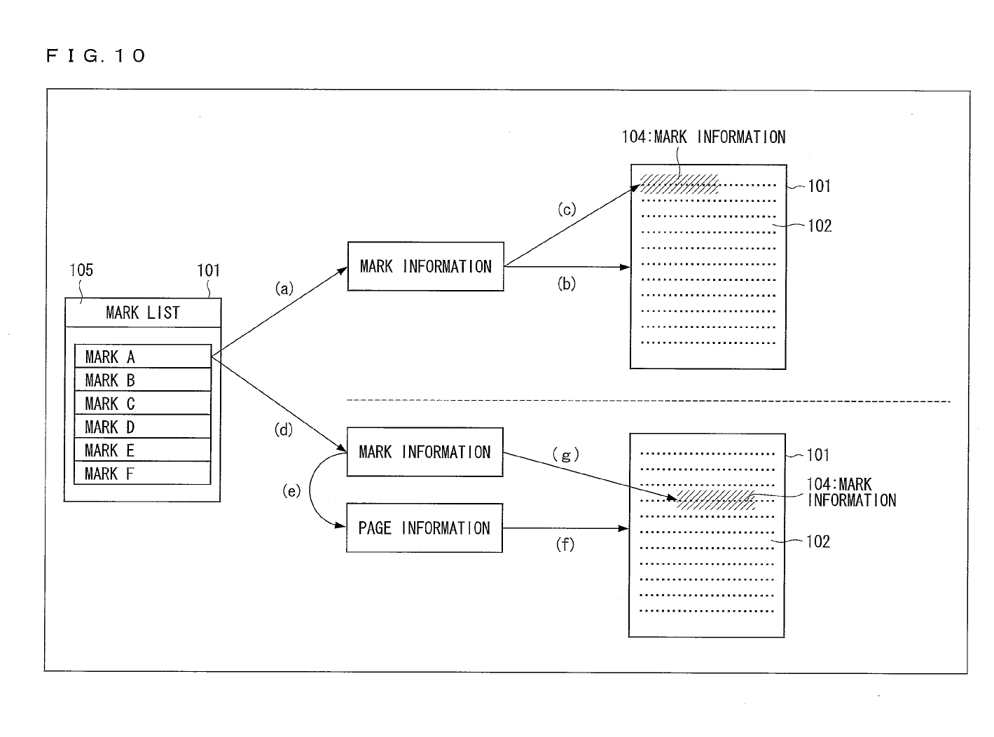

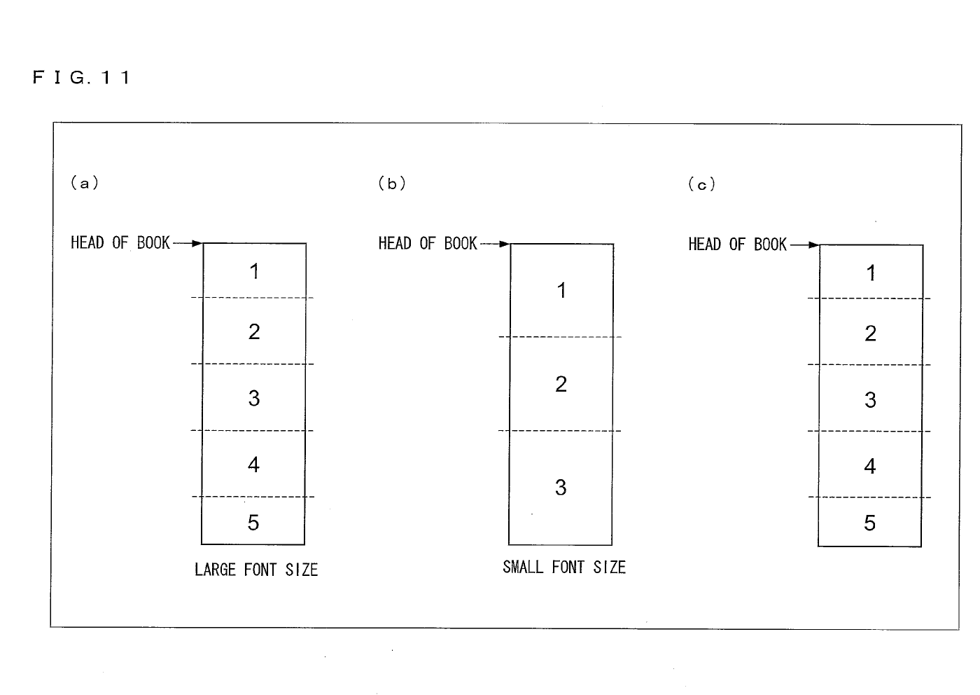

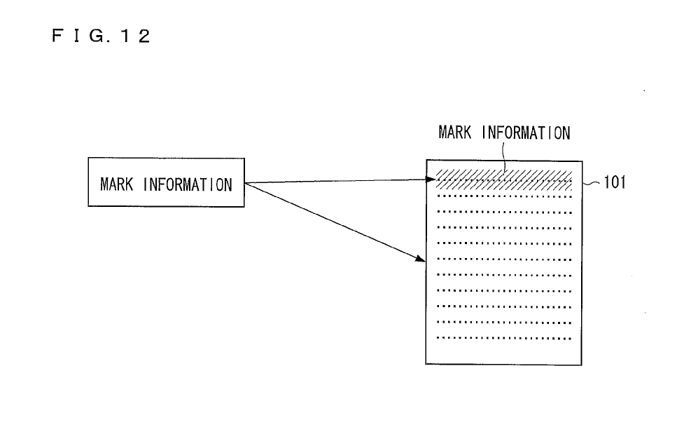

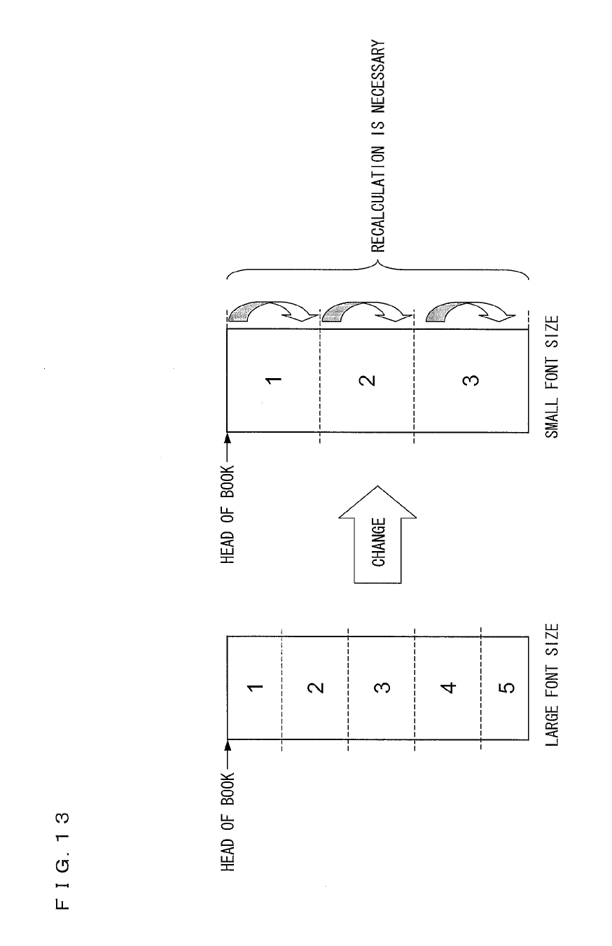

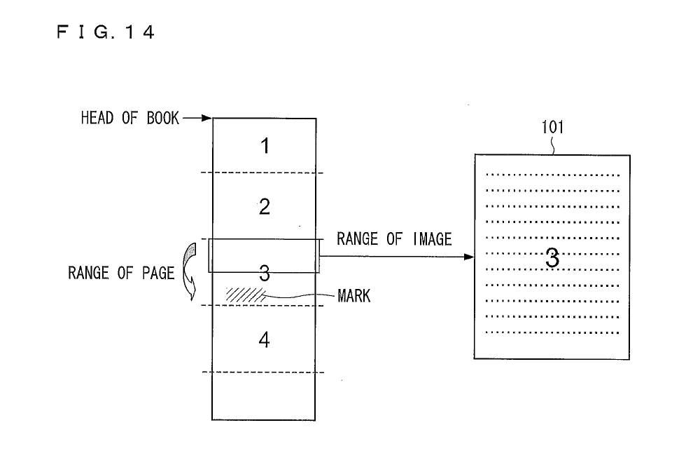

(a) of FIG. 9 is a screen image illustrating a state in which a mark is not displayed because of a change in font, and (b) of FIG. 9 is a screen image illustrating a state in which, when the mark is not displayed because of a change in font, a part which has been marked is moved to a head of information displayed on a display screen.

Note that Steps S21 through S24, S27, and S28 in the flowchart of FIG. 8 are identical to Steps S11 through S16 in the flowchart of FIG. 6, respectively. Processes of Steps S25 and S26 have been added in FIG. 8.

First, as shown in FIG. 8, a mark A is selected (Step S21). Specifically, a user selects the mark A, which is a desired mark, from the mark list 105 of (b) of FIG. 2. In response to this, the reproduction information acquiring section 123 acquires, from the reproduction information storage section 17, mark reproduction information (display location information, mark information) corresponding to the mark A, and transfers the mark reproduction information to the display data synthesizing section 121.

Next, the display data synthesizing section 121 acquires display location information of the mark A from the mark reproduction information (Step S22), and reproduces a display state in the internal image buffer on the basis of the display location information of the mark A (Step S23). Note that the display location information includes (A) a flow ID (here, in the case of the flow 3, ID=3) of a part of the electronic book information which part is located at a head of a display region and (B) location information in the flow (flow 3). Accordingly, as illustrated in (a) of FIG. 7, the display data synthesizing section 121 reproduces a display region where a part starting from ddd and ending with ggg of the flow 3 of the whole content is displayed.

Then, the display data synthesizing section 121 acquires the mark information of the mark A from the mark reproduction information (Step S24).

Next, the display data synthesizing section 121 determines, on the basis of the mark information of the mark A thus acquired, whether or not the mark A is included in the electronic book information displayed on the display screen (the display screen of the display panel 11a of the display section 11) shown with the use of display data which is equivalent to one screen and has been reproduced in the internal image buffer (Step S25). The display data synthesizing section 121 checks whether or not the mark is included in the electronic book information on the basis of information displayed in the internal image buffer. Specifically, the display data synthesizing section 121 determines whether or not the mark A is included in the display data (display screen) on the basis of (A) a start location and an end location of the display data which is equivalent to one screen and has been reproduced in the internal image buffer and (B) location information of the mark A.

In a case where the display data synthesizing section 121 determines that the mark A is included in the display screen in Step S25, the mark reproduction process proceeds to Step S27. On the contrary, in a case where the display data synthesizing section 121 determines that the mark A is not included in the display screen, the process proceeds to Step S26. For example, in a case where the user attempts to display the mark in a larger font size, a part where the mark A is added is not displayed in the electronic book information in the display screen with the use of the display location information (see (a) of FIG. 9).

As such, in Step S26, in order to display the mark A, the display data synthesizing section 121 corrects a display location of the mark on the basis of the mark information which has been acquired. Here, correction is made so that the mark is moved to a location of a head of information displayed on the display screen. This is the display state illustrated in (b) of FIG. 9. Note, however, that the display location of the mark is not limited to the location of the head of the information displayed on the display screen. The display location is not particularly limited, provided that the display location is within the display screen.

After the display location of the mark is corrected in Step S26, the process proceeds to Step S27.

In Step S27, the mark information which has been acquired is added by the display data synthesizing section 121 to display which has been reproduced in the internal image buffer. The mark information includes a flow data index (document flow ID of a document to which a mark has been added), a start location offset (a mark start location in the flow), an end location offset (a mark end location in the flow), a location in a book (a mark start location in the content (for sorting a list)), a page number (a location of the mark in the content (for displaying a location of the mark in the list)), a marker text string (text information of a selected marker), and a color of a line marker (a line color of the mark). Accordingly, as illustrated in (b) of FIG. 7, the display data synthesizing section 121 adds the mark to gg in the display region in the internal image buffer and adds gg as a mark region. In this way, the display data synthesizing section 121 reproduces, in the internal image buffer, display data which is equivalent to one screen and is constituted by (i) the mark and (ii) display including the mark.

Finally, the display data synthesizing section 121 transfers, to the display panel 11a of the display section 11, the display data reproduced in the internal image buffer (Step S28).

Even in a case where the mark cannot be displayed on the display screen to be reproduced because of a display setting (change in font size etc.), it is possible to cause, while maintaining the display setting, the mark to be displayed by reproducing, as described above, a display state at the time of adding the mark.

Accordingly, the mark is reproduced with the use of only the mark information in a case where the mark cannot be displayed. As such, in order to reproduce the mark, it is not necessary to recalculate page information every time the font size is changed, unlike conventional reproduction methods.

<Reproduction Method 3>

In the Reproduction methods 1 and 2, a font size at the time that the mark is added is not stored as the mark reproduction information. In the Reproduction method 3, however, font size information of the font size at the time that the mark is added may be also stored as the mark reproduction information, and the font size may be used when the mark is reproduced.

In this case, the use of the font size in reproduction of the mark allows the mark to be always reproduced even if a font size on the display screen at the time that the mark is reproduced is different from a font size at the time that the mark was added. This is because the display screen can be reproduced by causing the font size at the time that the mark is reproduced to be changed back to the font size at the time that the mark was added.

This process can be materialized by the block diagram of FIG. 1. For example, when acquiring display state information, the display state information acquiring section 132 acquires not only display state information but also information on the font size.

The display state information can include, in addition to the information on the font size, vertical writing/horizontal writing setting information which indicates whether the electronic book information is vertically written or horizontally written. In a case where the display state information includes vertical writing setting information which indicates that a display state of the electronic book information is vertical writing when the mark is added, the display state is changed to the vertical setting when the mark is reproduced, even if the display state of the electronic book information is set to be the horizontal writing. In a case where, as described above, the display state at the time that the mark was added is reproduced when the mark is reproduced, a user can easily recall a relationship between a display state before the mark was added and a display state thereof after the mark was added.

The electronic book display device of the present invention can be held by a user so as to be vertical or horizontal. Specifically, here, for example, a vertical length of the display screen of the display panel 11a of the display section 11 is longer than a horizontal length of the display screen of the display panel 11a of the display section 11. In this case, (i) a way in which the electronic book display device is held by the user so that the shorter side of the display screen is at the top when viewed by the user is referred to as vertical holding, and (ii) a way in which the electronic book display device is held by the user so that the longer side of the display screen is at the top when viewed by the user is referred to as horizontal holding.

Accordingly, in a case where whether the electronic book display device is vertically held or horizontally held can be set in the electronic book display device, the display state information can further include vertical holding/horizontal holding setting information that defines how the electronic book display device is held by a user when the mark is added. In this case, when the mark is reproduced, (i) a state in which the electronic book information is displayed so that the electronic book display device is vertically held or (ii) a state in which the electronic book information is displayed so that the electronic book display is horizontally held is also reproduced on the basis of the vertical holding/horizontal holding setting information at the time that the mark was added, which vertical holding/horizontal holding setting information is included in the display state information. At this time, in a case where setting of vertical holding/horizontal holding of the electronic book information varies every time when a mark is added, the electronic book display device gives an information sign or the like to urge the user to hold the electronic book display device in a way to be reproduced. In a case where, as described above, the display state at the time that the mark was added is reproduced when the mark is reproduced, the user can easily recall a relationship between a display state before the mark was applied and a display state thereof after the mark was added.

As described above, the display state information is preferably the data location information of the electronic book information, which data location information indicates a location of a head of information displayed on the display screen of the display means among the electronic book information.

Note that the data location information of the electronic book information at the top of the display screen of the display means indicates a display location of data which is displayed first when the display data equivalent to one screen of the display screen of the display means is displayed.

As described above, if the display location of the data which is displayed first when the display data equivalent to one screen of the display screen of the display means is displayed, when display is reproduced,

In addition, the display state information is preferably includes: the display state information includes: data location information of the electronic book information displayed on a display screen of the display means; font size information; vertical writing/horizontal writing setting information that indicates whether the electronic book information is vertically written or horizontally written; and vertical holding/horizontal holding setting information that defines how the electronic book display device is held by a user.

First, in a case where the display state information includes the font size information, the font size is also used in reproduction of the mark. Accordingly, even if the font size on the display screen at the time that the mark is reproduced is different from a font size at the time that the mark is added, the mark can be always reproduced. This is because the display screen can be reproduced by causing the font size at the time that the mark is reproduced to be changed back to the font size at the time that the mark was added.

In a case where the display state information includes the vertical writing/horizontal writing setting information, it is possible to cause, at the time of reproducing the mark, a setting to be changed back to a setting (vertical writing or horizontal writing) which was set when the mark was added. For example, in a case where the display state information includes vertical writing setting information which indicates that the display state of the electronic book information was vertical writing when the mark was added, the display state is changed, when the mark is reproduced, to the vertical writing setting even if the display state of the electronic book information is set to be the horizontal writing. In this way, reproducing, at the time of reproducing the mark, a display state at the time that the mark was added allows the user to easily recall a relationship between a display state before the mark was added and a display state after the mark is was added.

In a case where the display state information includes the vertical holding/horizontal holding setting information, the vertical holding or the horizontal holding, set when the mark is added, of the electronic book information is reproduced when the mark is reproduced. If the display means is set so that the state displayed when the mark is added is reproduced when the mark is reproduced, the user can easily imagine a relationship between a display state before the mark is added and a display state after the mark is added.

Further, the electronic book display device includes: display determination means for determining whether or not the mark is displayed on the display means in a case where the mark is displayed, by means of the mark addition means, at a predetermined location of the electronic book information which has been reproduced; and mark information display update means for updating the display state with the use of the mark information in a case where the display determination means determines that the mark is not displayed on the display means.

According to the aforementioned arrangement, in a case where whether or not the mark is displayed on the display screen of the display means is determined when the mark is reproduced, and as a result of the determination, the mark is not displayed, reproduction of the mark is performed with the use of the only mark information. This makes it possible to prevent a situation where a desired mark is not displayed to the display means when the mark is reproduced.

<Program and Recording Medium>

The first information processing section 12 and the second information processing section 13 included in the electronic book display device can be configured with the use of a hardware logic. Alternatively, the first information processing section 12 and the second information processing section 13 can be realized by software with the use of a CPU (Central Processing Unit).

Specifically, the first information processing section 12 and the second information processing section 13 each include: a CPU, such as an MPU, for executing commands of a program to realize each function; a ROM (Read Only Memory) which stores the program; a RAM (Random Access Memory) in which the program is developed in an executable format; and a storage device (recording medium), such as a memory, which stores the program and various kinds of data.

The object of the present invention is not limited to a case where an electronic book display program for realizing the first information processing section 12 and the second information processing section 13 is fixedly stored, and the object of the present invention can be achieved by supplying, to the first information processing section 12 and the second information processing section 13, a recording medium in which program codes (execution mode program, intermediate code program, and source program) of the program are recorded and reading out and executing the program codes stored in the recording medium.

The recording medium is not limited to one having a particular structure or a particular kind of recording medium. That is, examples of the recording medium encompass: tapes such as a magnetic tape and a cassette tape; disks such as magnetic disks (e.g., floppy (registered trademark) disk and hard disk) and optical disks (e.g., CD-ROM, MO, MD, DVD, and CD-R); cards such as an IC card (including a memory card) and an optical card; and semiconductor memories (e.g., mask ROM, EPROM, EEPROM, and flash ROM).

The object of the present invention can be achieved by configuring the first information processing section 12 and the second information processing section 13 to be connected to a communication network. In this case, the program code is supplied via the communication network. The communication network is not limited to a particular kind or form, provided that the communication network supplies a program code to the first information processing section 12 and the second information processing section 13. Examples of the communication network encompass the Internet, intranet, extranet, LAN, ISDN, VAN, CATV communication network, virtual private network, telephone network, mobile communication network, and satellite communication network.

A transmission medium constituting the communication network is not limited to a particular arrangement or kind, provided that the transmission medium can transmit a program code. Examples of the transmission medium encompass: wired transmission media such as IEEE1394, a USB, a power-line carrier, a cable TV line, a telephone line, and an ADSL; and wireless transmission media such as infrared rays (e.g., IrDA and a remote controller), Bluetooth (registered trademark), 802.11 wireless, an HDR, a cell-phone network, and a satellite line, and a digital terrestrial network. Note that the present invention may be also realized by a computer data signal which has the program codes specified with electronic transmission and is embedded in a carrier wave.

The present invention is not limited to the description of the embodiments above, and can be modified in numerous ways by a skilled person as long as such modification falls within the scope of the claims. An embodiment derived from a proper combination of technical means disclosed in different embodiments is also encompassed in the technical scope of the present invention.

### INDUSTRIAL APPLICABILITY

The present invention is applicable to a device, in particular, a portable display device, for reproducing a part where a user added a mark in electronic data such as electronic book information.

### REFERENCE SIGNS LIST

11 display section (display means)
11a display panel
11b touch panel
12 first information processing section
13 second information processing section
14 mark addition section (mark addition means)
15 mark selection section
16 book data storage section
17 reproduction information storage section (storage means)
18 mark list storage section
19 page designation section
20 mark list display designation section
101 display screen
102 electronic book information
103 pen
104 mark
105 mark list
121 display data synthesizing section (display reproduction means, display determination means, mark information display update means)
122 book data acquiring section
123 reproduction information acquiring section (information reading out means)
124 mark list acquiring section
131 mark information acquiring section
132 display state information acquiring section
133 mark list making section

1. An electronic book display device, comprising:
display means for displaying electronic book information;
mark addition means for adding a mark to a text of the electronic book information displayed on the display means; and
storage means for (A) causing (a) mark information of the mark which has been added by the mark addition means to the text of the electronic book information and (b) display state information, which indicates a display state of the electronic book information at a time that the mark was added, to be associated with each other so as to obtain reproduction information in which the mark information and the display state information are associated with each other and (B) storing the reproduction information,
the display means displaying the electronic book information and the mark on the basis of the reproduction information of the storage means when the display means displays the electronic book information in which the mark has been added.

2. The electronic book display device as set forth in claim 1,
wherein the display state information is data location information of the electronic book information, the data location information indicating a location of a head of information displayed on a display screen of the display means among the electronic book information.

3. The electronic book display device as set forth in claim 1,
wherein the display state information includes: data location information of the electronic book information displayed on a display screen of the display means; font size information; vertical writing/horizontal writing setting information that indicates whether the electronic book information is vertically written or horizontally written; and vertical holding/horizontal holding setting information that defines how the electronic book display device is held by a user.

4. An electronic book display device as set forth in claim 1, further comprising:
display determination means for determining whether or not the mark is displayed on the display means in a case where the mark is displayed, by means of the mark addition means, at a predetermined location of the electronic book information which has been reproduced; and
mark information display update means for updating the display state with the use of the mark information in a case where the display determination means determines that the mark is not displayed on the display means.

5. A method for displaying an electronic book in an electronic book terminal including: display means for displaying electronic book information; and storage means for (A) causing (a) mark information of a mark which has been added to a text of the electronic book information and (b) display state information, which indicates a display state of the electronic book information at a time that the mark was added, to be associated with each other so as to obtain reproduction information in which the mark information and the display state information are associated with each other and (B) storing the reproduction information, the method comprising the steps of:
(i) reading out the reproduction information stored in the storage means;
(ii) reproducing, on the basis of the display state information included in the reproduction information which has been read out in the step (i), the display state of the electronic book information at the time that the mark was added; and
(iii) displaying, with the use of the mark information included in the reproduction information read out in the step (i), the mark at a predetermined location of the electronic book information which has been reproduced in the step (ii).

6. (canceled)

7. A computer-readable recording medium in which an electronic book display program for use in an electronic book terminal including: display means for displaying electronic book information; and storage means for (A) causing (a) mark information of a mark which has been added to a text of the electronic book information displayed on the display means and (b) display state information, which indicates a display state of the electronic book information at a time that the mark was added, to be associated with each other so as to obtain reproduction information in which the mark information and the display state information are associated with each other and (B) storing the reproduction information, the program causing a computer to carry out the following processes of:
(i) reading out the reproduction information stored in the storage means;
(ii) reproducing, on the basis of the display state information included in the reproduction information which has been read out in the process (i), the display state of the electronic book information at the time that the mark was added; and
(iii) displaying, with the use of the mark information included in the reproduction information read out in the process (i), the mark at a predetermined location of the electronic book information which has been reproduced in the process (ii) is recorded.
